(19) United States
(12) Patent Application Publication
(10) Pub. No.: US 2024/0375362 A1
(43) Pub. Date: Nov. 14, 2024

(54) APPARATUS FOR MOLDING A SHELL ELEMENT MADE OF COMPOSITE MATERIAL, PARTICULARLY A HULL OF A BOAT, AND METHOD THEREOF

(71) Applicant: PERMARE S.R.L., Sanremo (Imperia) (IT)

(72) Inventor: Barbara AMERIO, Sanremo (Imperia) (IT)

(21) Appl. No.: 18/690,003

(22) PCT Filed: Sep. 16, 2022
(86) PCT No.: PCT/IB2022/058752

§ 371 Date: Mar. 7, 2024

(30) Foreign Application Priority Data
Sep. 17, 2021 (IT) 102021000023918

(51) Int. Cl. B29C 70/54; B29C 37/00; B29L 31/30; B63B 73/72

(52) U.S. Cl. CPC B29C 70/54; B63B 73/72; B29C 2037/903; B29L 2031/307

(57) ABSTRACT

Provided is an apparatus for molding a shell hull made of composite material for a boat having a first mold part and a second mold part, each having a molding surface and adapted to be coupled to jointly define a concave molding cavity that extends longitudinally between a stern end and a bow end. The apparatus has a humidity sensor for detecting humidity at the first and/or second mold parts. A plurality of sensors, arranged in a respective plurality of detection positions on a detection surface extending over at least one of the first mold part and the second mold part, and arranged directly in contact therewith, produce signals representative of respective strains of the detection surface in directions substantially perpendicular to the detection surface.

### TECHNICAL FIELD

The present invention is, in general, in the field of molding shell components for use in the nautical industry, and in particular in the field of molding hulls or keels made of a composite material for boats, whether sailing or motor boats, and particularly for large boats.

### PRIOR ART

Molds are generally known to be used for the production of shell elements, particularly for the production of hulls or keels, particularly those made of composite materials. Generally, in the process of manufacturing a hull made of composite material for a boat, a plurality of mold parts is coupled to make a molding cavity that defines the shape of the hull. Layers of reinforcement material, such as, for example, fiber, or fibrous material, are then arranged on the surface of the molding cavity, called the molding surface. Said materials are covered with vacuum bags. Subsequently, in the space between the vacuum bag and the molding surface, the die is injected, or generally a molten thermosetting material, such as, for example, a thermosetting resin. Finally, the assembly undergoes a polymerization process, advantageously in an autoclave. In the nautical field, however, the size of shell elements made in molds in such a manner is considerable, and may reach and exceed 300 square meters. As a result, it is very important to be able to check the structural stability of the mold, or the mold parts that make up the mold, and to verify that the shape of the mold remains the same over time, so that the molding process takes place as uniformly as possible during the production of different parts. Moreover, when the mold or mold parts are not in use, they are generally stored in the open or otherwise outdoors, precisely because of the large size typical in the shipbuilding industry. As a result, during times of non-use or preparation, molds or mold parts may be affected by weathering and/or changes in temperature (with temperature changes of up to 40° C. over the year), pressure and humidity, risking inadvertent strain. It should further be taken into account that said molds are a valuable capital asset in the shipbuilding industry.

### SUMMARY OF THE INVENTION

The object of the present invention is to overcome the problems described, and to provide a solution to the drawbacks of the prior art.

A further object of the present invention is to determine the best environmental and stress conditions for manufacturing a shell element by molding.

Finally, a further object of the present invention is to make the process of manufacturing shell elements made of composite material by means of molding more economical.

The aforesaid and other objects and advantages are obtained with a molding apparatus having the features defined in claim 1, as well as a related monitoring method having the features defined in claim 9 and a manufacturing method having the features defined in claim 12.

Advantageous embodiments of the invention are specified in the dependent claims, the content of which is to be understood as an integral part of the description that follows.

In summary, the invention is based on the idea of providing an apparatus for molding a shell hull, made of composite material, of a boat, the apparatus comprising:
a first mold part and a second mold part, wherein said first mold part and said second mold part each have a respective molding surface, said first mold part and said second mold part being suitable to be coupled together to define a concave molding cavity for molding a shell hull made of composite material, the molding cavity being delimited on two opposite sides by the respective molding surfaces of said first mold part and said second mold part and extending longitudinally between a stern end and a bow end;
a humidity sensor suitable for detecting humidity at the first part of the mold and/or the second part of the mold;
a plurality of sensor means, arranged in a plurality of respective detection positions on a detection surface of at least one of said first mold part and said second mold part, and arranged directly in contact with at least one of said first mold part and said second mold part, the detection surface being arranged opposite to the molding surface of said mold part; wherein the sensor means are adapted to produce a plurality of signals representative of respective strains of the detection surface in directions substantially perpendicular to the detection surface at the respective detection positions.

By virtue of the arrangement of the sensor means, it is possible to detect any strains of the detection surface, and thus of the first part of the mold and/or the second part of the mold, in directions substantially perpendicular to the detection surface at the detection positions where the sensor means are arranged, and, if necessary, to prepare corrective or repairing actions for said strains.

### BRIEF DESCRIPTION OF THE DRAWINGS

The features and advantages of the present invention will be clarified by the detailed description that follows, given purely by way of non-limiting example and with reference to the attached drawings, in which:

FIG. 1 is a perspective view of an apparatus according to an embodiment of the invention;

FIG. 2 is an exploded view of the apparatus shown in FIG. 1; and

FIG. 3 is a lateral view of a first mold part of an apparatus according to a further embodiment of the invention.

### DETAILED DESCRIPTION

Before describing in detail a plurality of purely exemplifying embodiments of the invention, it should be clarified that the invention is not limited in its application to the construction details and to the configuration of the components presented in the following description or illustrated in the drawings. The invention may assume other embodiments and be implemented or constructed in practice in different ways. It should also be understood that the phraseology and terminology have a descriptive purpose and should not be construed as limiting. The use of “include” and “comprise” and the variations thereof are intended to cover the elements set out below and their equivalents, possibly also as additional elements and the equivalents thereof.

Terms such as “stem”, “bow”, “midship section”, “starboard”, “port”, and “longitudinally”, in the context of the present description and the attached claims are to be interpreted within the normal meaning they have in the nautical industry.

In the context of this description and the attached claims, “shell element” means a structural element having a thickness much smaller than its width and height, such as, for example, a hull, a keel, or part thereof, or a panel.

In reference to the figures, the apparatus according to the invention is indicated generally with 10. The apparatus 10 is suitable for use in molding a shell element made of composite material, particularly for molding a hull or a keel of a boat or vessel.

In addition, or as an alternative, the apparatus may be used for molding a shell hull made of biocomposite material.

The term biocomposite material refers to a special type of composite material in which a matrix is reinforced with one or more types of fibers of plant origin, for example a resin matrix reinforced with basaltic fibers or bamboo fibers, in such a way as to obtain a material with superior mechanical properties with respect to the source materials taken individually, and one that is more biodegradable, or more easily recyclable than a traditional composite material.

The apparatus 10 essentially comprises a first mold part 12, a second mold part 14, a plurality of sensor means 16 and a humidity sensor 17.

The first mold part 12 and the second mold part 14 are formed as generally thin bodies, for example of a maximum thickness of about 1 cm. In a preferred embodiment, the first mold part 12 and the second mold part 14 are essentially similar and symmetrical in shape. The first mold part 12 and the second mold part 14 each have a respective molding surface, specifically they have a first molding surface 12a and a second molding surface 14a. In essence, the first mold part 12 and the second mold part 14 have such a shape, or are adapted, to be coupled so as to integrally define a molding cavity 18. The molding cavity 18 is essentially concave, extending longitudinally, or in a longitudinal direction x, between a stern end 20 and a bow end 22, and is delimited on two opposite sides by the first molding surface 12a and the second molding surface 14a.

As mentioned above, the apparatus 10 further comprises a plurality of sensor means 16. The sensor means 16 are arranged on a detection surface 24 that extends over at least one of the first mold part 12 and the second mold part 14.

Preferably, the sensor means 16 may be arranged in contact, or directly in contact with at least one of the first mold part 12 and the second mold part 14.

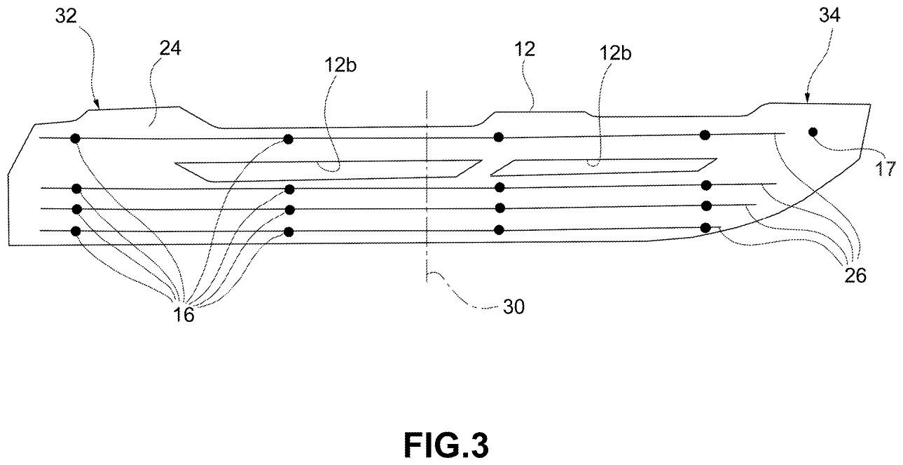

More preferably, the sensor means 16 are arranged on both the first mold part 12 and the second mold part 14, or the detection surface 24 extends partly on the first mold part 12 and partly on the second mold part 14. Hereinafter, only the embodiment of the invention for which the sensor means are arranged exclusively on the first mold part 12, or in which the detection surface 24 extends entirely over the first mold part 12, as also shown in FIG. 3, will be described, with the understanding that the invention further comprises embodiments in which the sensor means 16 are arranged at least partially, or only, on the second mold part 14. In particular, the detection surface 24 is arranged opposite to the molding surface 12a (or 14a) of the first mold part 12 (or the second mold part 14). Essentially, the detection surface 24 is arranged externally on the first mold part 12 (and/or on the second mold part 14).

The sensor means 16 are suitable for detecting the strain of the first mold part 12 (and/or the second mold part 14), and in particular for detecting, measuring, and/or determining the strain of the detection surface 24 along the direction substantially perpendicular to said detection surface 24 in the detection position of each sensor means 16, or are adapted to generate a respective plurality of signals representative of the strain of the first mold part 12 and/or the second mold part along directions substantially perpendicular to the detection surface 24 in the respective detection positions.

With the object of measuring respective strains of the detection surface 24, the sensor means 16 may be provided, for example, in the form of strain gauges and/or piezoelectric transducers arranged in contact, or directly in contact, with the first mold part 12 and/or the second mold part 14.

In this way, the apparatus 10 is able to produce a plurality of signals, in a plurality of detection positions, through the relevant plurality of sensor means 16, these signals being representative of the strain of the detection surface 24 of the first mold part 12 (and/or the second mold part 14) in the direction essentially orthogonal to said detection surface 24 at the point where the sensor means 16 is positioned, or at the respective detection position.

The detection signals representative of the strain of the detection surface that are produced by the sensor means 16 may then be transmitted to an electronic control unit 19 (not shown), and even more preferably be processed thereby, to determine if, where, and when the first mold part 12 and/or the second mold part 14 have undergone significant structural strains and possibly to determine or suggest to an operator the need for maintenance work aimed at repairing the first mold part 12 and/or the second mold part 14.

As is visible in the figures, the sensor means 16 may be, for example, distributed along rows 26, each row 26 comprising part of the plurality of sensor means 16. The different rows 16 may be arranged, for example, so as to extend longitudinally between the stern end 20 and the bow end 22, or so as to be substantially parallel and spaced apart, or arranged at different “heights,” or at different positions in a plane perpendicular to the longitudinal direction x. Preferably, the sensor means 16 of different rows 26 are arranged in substantially corresponding longitudinal positions, as clearly visible in FIG. 3, or the sensor means 16 of different rows 26 are grouped together in groups that are located at a common longitudinal position.

Preferably, the sensor means 16 of each row 26 are electrically connected in series with each other for their power supply.

In addition, the sensor means 16 of each row 26 may be electrically connected in series with each other to transmit strain data to the electronic control unit 19.

The sensor means 16 may be glued to the detection surface 24, or they may each be fixed in their respective detection position by conventional mechanical fastening means.

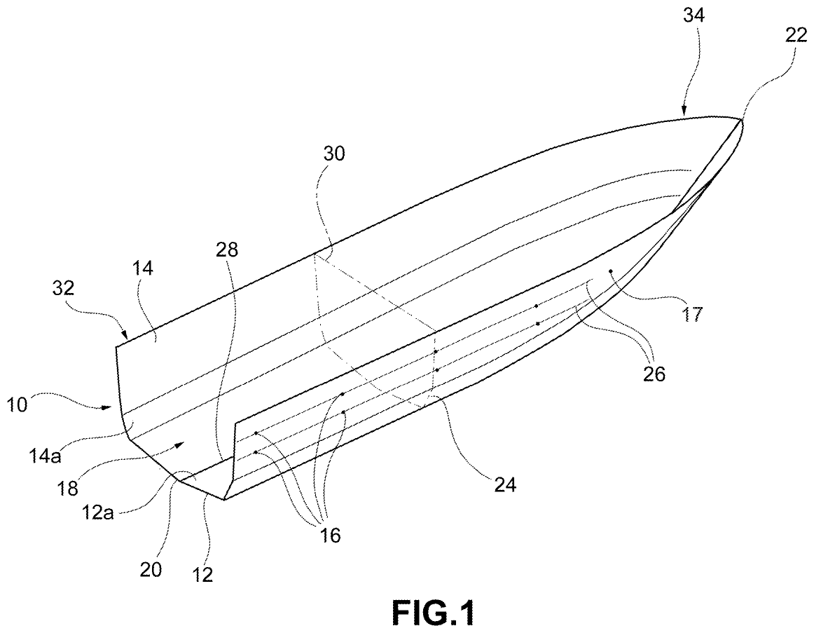

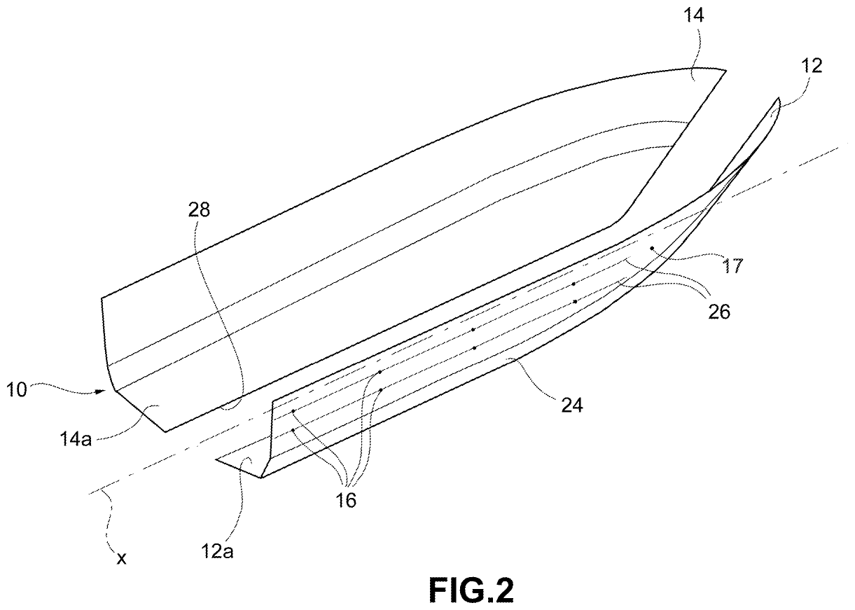

In a preferred embodiment of the invention, the sensor means 16 are arranged on the detection surface 24 so that at least part of the sensor means 16 is arranged on either side with respect to a keel centerline 28 (of the shell member, or the hull, to be molded), or with respect to a diametral plane or with respect to a centerboard plane of the hull and/or the first mold part 12 and/or the second mold part 14. Specifically, in the embodiment in which the first mold part 12 and the second mold part 14 each delineate an exact half of the hull or shell element to be molded, the keel centerline 28 will correspond to the line of union between the first mold part 12 and the second mold part 14, or the line where the two mold parts touch and connect to form the molding cavity 18, as shown in FIG. 1 and FIG. 2. Specifically, in a preferable embodiment, the sensor means 16 may be arranged on the detection surface 24 so that:
at least part of the plurality of sensor means 16 is arranged along the keel centerline 28, or lying in the diametral or centerboard plane, of the first mold part 12 or the second mold part 14; and
at least part of the plurality of sensor means 16 is arranged on a starboard side, or a right side, with respect to the keel centerline 28, or with respect to the diametral or centerboard plane, of the first mold part 12 or the second mold part 14; and
at least part of the plurality of sensor means 16 is arranged on a port side with respect to the keel centerline 28, or with respect to the diametral or centerboard plane, of the first mold part 12 or the second mold part 14, the port side being arranged opposite the starboard side of the first mold part 12 or the second mold part 14 with respect to the keel centerline 28, or with respect to the diametral or centerboard plane.

In a preferred embodiment of the invention, the sensor means 16 are arranged on the detection surface 24 in such a way that at least part of the sensor means 16 is arranged on either side with respect to a plane on which a midship section 30 lies, or a section of maximum relative size, or with respect to a plane perpendicular to the longitudinal direction x of the hull and/or of the first mold part 12 and/or of the second mold part 14. Essentially, therefore, in this embodiment the sensor means 16 are arranged partly on a bow side 34 and partly on a stern side 32. Specifically, the sensor means 16 may be arranged on the detection surface 24 so that:
at least part of the plurality of sensor means 16 is arranged at the midship section 30 of the first mold part 12 or the second mold part 14; and
at least part of the plurality of sensor means 16 is arranged on a stern side 32 with respect to the midship section 30 of the first mold part 12 or of the second mold part 14; and
at least part of the plurality of sensor means 16 is arranged on a bow side 34 with respect to the midship section 30 of the first mold part 12 or the second mold part 14, the stern side 32 being arranged opposite the bow side 34 of the first mold part 12 or the second mold part 14 with respect to the midship section 30.

Clearly, as is clear to the person skilled in the art, the bow side 34 and the stern side 32 are arranged at the bow end 22 and the stern end 20, respectively.

As is clear to the person skilled in the art, each of said sensor means 16, being adapted to generate a signal representative of the strain of the detection surface 24 (of the first mold part 12 and/or the second mold part 14) in a direction perpendicular to said detection surface 24, is parameterized with respect to the thickness of the mold part to which it is fixed, or the first mold part 12 or the second mold part 14, at the point where it is mounted, or at the detection position.

The apparatus 10 further comprises a humidity sensor 17 suitable for detecting the humidity in the environment or in the air at the first mold part 12 and/or the second mold part 14.

Preferably, the humidity sensor 17 transmits the result of this detection to the electronic control unit 19.

In a preferred embodiment, the apparatus 10 may further comprise a temperature sensor adapted to detect the ambient air temperature at the first mold part 12 and/or the second mold part 14, or detecting the temperature of the first mold part 12 and/or the second mold part 14, and transmitting the result of said detection to the electronic control unit. It is also possible for the apparatus 10 to comprise one or more environmental sensors each adapted to measure at least temperature and humidity, and/or additional useful environmental parameters.

Alternatively, the sensor means 16 may also be arranged in “scattered,” or cloud-like configurations, or in detection positions of the detection surface 24 that do not necessarily follow a fixed and repeated geometric pattern.

In an embodiment of the invention, the sensor means 16 are wireless sensor means 16, whereby they may be battery-powered and/or may transmit and receive the detection data via a wireless communication means.

In the embodiment of FIG. 3, in particular, a first mold part 12 is shown having a complex shape and having a plurality of openings 12b, shaped for the arrangement of any additional structural elements or windows or glass. By way of example, on said first mold part 12, four rows 26 of sensor means 16 are arranged, each row 26 comprising four different sensor means 16.

According to a second aspect of the invention, a method for monitoring a mold for molding a shell hull, made of composite material, of a boat also forms part of the invention, comprising the steps of:
a) arranging an apparatus 10 according to the first aspect of the invention;
b) generating, at a plurality of detection positions, by means of said sensor means 16, a plurality of signals representative of respective strains of the detection surface 24 of the first mold part 12 and/or the second mold part 14, in directions substantially perpendicular to the detection surface 24.

Preferably, the monitoring method of a mold also comprises the steps of:
c) transmitting said plurality of signals to an electronic control unit 19;
d) processing said plurality of signals by means of said electronic control unit 19.

More preferably, depending on the outcome of what is generated in step b) and/or the processing carried out in step d), a repair action may be carried out. In fact, if the sensor means 16 detect a strain beyond a tolerance threshold at one or more sensing positions, it will be possible to repair the first mold part 12 or the second mold part 14 in a timely manner, or by applying, adding, or removing material only in the sensing positions where the sensor means 16 will have detected a strain.

The definition of the repair action, which means the definition of the amount of material to be added or removed on one or more sensing positions of the molding surface 24, may be carried out by means of the electronic control unit 19 on the basis of the representative strain signals and/or the processing thereof.

Preferably, the strains of the first mold part 12 and/or the second mold part 14 are determined automatically by the electronic control unit 19 and the repair action of the strains is automated.

The monitoring method may, preferably, be used continuously, or it may be used either during the use of the first mold part 12 and/or the second mold part 14, or when these parts are “at rest,” or left unused in storage or outdoors.

According to a third aspect of the invention, a method of manufacturing a shell hull, made of composite material, of a boat also forms part of the invention, comprising the steps of:
x1) carrying out monitoring according to the method of the second aspect of the invention;
x2) arranging at least one layer of reinforcement material, or fibrous material, such as glass fiber, within said molding cavity 18; and
x3) following step x2), injecting a thermosetting resin inside said molding cavity 18 so as to fill said molding cavity 18, or so as to essentially cover the molding surface 12a and/or 14a entirely, or injecting a thermosetting resin inside a vacuum bag or curing bag arranged so as to essentially cover the molding surface 12a and/or 14a entirely.

Preferably, in the manufacturing method according to the third aspect of the invention, step b) of producing, at a plurality of detection positions, through said sensor means 16, a plurality of signals representative of respective strains of the detection surface 24 of the first mold part 12 and/or the second mold part 14, in directions substantially perpendicular to the detection surface 24, is carried out at least in part during at least one of either step x2) and step x3). Thus, in essence, preferably at least part of the detection of the monitoring method takes place during the step of arranging the reinforcement material layer and/or during the step of injecting the thermosetting resin.

Preferably, the manufacturing method according to the third aspect of the invention may also comprise the step of:
x4) following step x3), subjecting the reinforcement material layer, or fibrous material, and the thermosetting resin inside the molding cavity 18 to a vacuum bag autoclave polymerization process according to a specific pressure and temperature cycle.

In order to carry out step x4), a curing bag, or vacuum bag, is typically applied so as to fully cover the molding cavity 18 and the molding surface 12a and/or 14a of the first mold part 12 and/or the second mold part 14. The application of said curing bag, or vacuum bag, is done before step x3), or before injecting thermosetting resin inside the molding cavity 18.

Even more preferably, the manufacturing method according to the third aspect of the invention may further comprise the step of arranging a layer of waxy material on the molding surface 12a and/or 14a of the first mold part 12 and/or the second mold part 14, respectively, prior to step x2). The arrangement of said layer of waxy material facilitates the separation of the item, i.e., the shell element, from the molding surface 12a and/or 14a, the first mold part 12 and/or the second mold part 14, respectively, after the autoclave curing process.

As is evident from the foregoing detailed description, several advantages may be achieved by the apparatus according to the invention and related methods.

First, through the use of sensor means, it is possible to check in a more or less extended time interval whether the mold is straining, or whether the first mold part and/or the second mold part undergoes any strain due to stress or environmental conditions. It is possible to perform such a check either during use, or during molding, or at times when the mold is not in use, for example when the mold is stored unused in storage or outdoors.

In addition, due to the arrangement of the sensor means, the exact location of any detected strains may be accurately determined.

Finally, in this way, repair actions may be taken on the mold, which means on the first mold part and/or the second mold part. In this way, the remaining useful life of the molds is clearly extended. In fact, by being able to detect defects or strains directly on the mold, it is possible to correct these defects or strains on the mold while avoiding the more costly need to correct the defects or strains on each molded item, i.e., on each shell element, which means on each hull produced using the mold.

Ultimately, it will be possible to correlate the detections from the sensor means with those of the humidity or temperature sensors, or with additional contextual information, and with information about the quality of the resulting product, or the molded shell element, making it possible to determine which operating conditions ensure higher product quality.

Various aspects and embodiments of an apparatus according to the invention have been described. It is understood that, in a way that is in itself obvious and equivalent to what is being is claimed, each embodiment of the invention may be combined with any other embodiment of the invention, insofar as they are compatible, without thereby falling outside the scope defined by the attached claims.

Of course, the invention is not limited to the embodiments described purely by way of example, but may be varied within the scope defined by the appended claims.

1. An apparatus for molding a shell hull, made of composite material, of a boat, the apparatus comprising:
a first mold part and a second mold part, wherein the first mold part and the second mold part each have a respective molding surface,
the first mold part and the second mold part being adapted to be coupled to define jointly a concave molding cavity for molding the shell hull of the boat,
the molding cavity being delimited on two opposed sides by the respective molding surfaces of said first mold part and of said second mold part, and extending longitudinally between a stern end and a bow end;
a humidity sensor adapted to detect humidity at the first mold part and/or at the second mold part; and
a plurality of sensor means, arranged in a respective plurality of detection positions on a detection surface that extends on at least one of said first mold part, and arranged directly in contact with at least one of said first mold part and said second mold part, the detection surface being arranged opposite to the molding surface of such mold part;
wherein the sensor means of the plurality of sensor means are adapted to generate a plurality of signals representative of respective strains of the detection surface in directions substantially perpendicular to the detection surface in the respective detection positions.

2. The apparatus of claim 1, wherein the sensor means are distributed in rows which are transversely spaced and which extend longitudinally between the stern end and the bow end.

3. The apparatus of claim 2, wherein sensor means of different rows are arranged in substantially corresponding longitudinal positions.

4. The apparatus of claim 2, wherein the sensor means of each row are electrically connected in series with each other to supply power and/or to transmit data.

5. The apparatus of claim 1, wherein the sensor means are arranged on the detection surface in such a way that:
at least part of the plurality of sensor means is arranged along a keel centerline of the first mold part or of the second mold part; and
at least part of the plurality of sensor means is arranged on a starboard side with respect to the keel centerline of the first mold part or of the second mold part; and
at least part of the plurality of sensor means is arranged on a port side with respect to the keel centerline of the first mold part or of the second mold part, the port side being arranged opposite to the starboard side of the first mold part or of the second mold part relative to the keel centerline.

6. The apparatus of claim 1, wherein the sensor means are arranged on the detection surface in such a way that:
at least part of the plurality of sensor means is arranged at a midship section of the first mold part or of the second mold part; and
at least part of the plurality of sensor means is arranged on a stern side with respect to the midship section of the first mold part or of the second mold part; and
at least part of the plurality of sensor means is arranged on a bow side with respect to the midship section of the first mold part or of the second mold part, the stern side being arranged opposite to the bow side of the first mold part or of the second mold part relative to the midship section.

7. The apparatus of claim 1, wherein the plurality of sensor means is arranged in a plurality of respective detection positions on respective detection surfaces of both said first mold part and second mold part, the respective detection surface of the first mold part or of the second mold part being arranged opposed to the molding surface of the respective mold part.

8. The apparatus of claim 1, further comprising a temperature sensor adapted for detecting temperature at the first mold part and/or at the second mold part.

9. A method for monitoring a mold for molding a shell hull, in composite material, of a boat, the method comprising:
(a) providing an apparatus for molding the shell hull, the apparatus comprising:
a first mold part and a second mold part, wherein the first mold part and the second mold part each have a respective molding surface,
the first mold part and the second mold part being adapted to be coupled to define jointly a concave molding cavity for molding the shell hull of the boat, the molding cavity being delimited on two opposed sides by the respective molding surfaces of said first mold part and of said second mold part, and extending longitudinally between a stern end and a bow end;
a humidity sensor adapted to detect humidity at the first mold part and/or at the second mold part; and
a plurality of sensor means, arranged in a respective plurality of detection positions on a detection surface that extends on at least one of said first mold part and said second mold part, and arranged directly in contact with at least one of said first mold part and said second mold part, the detection surface being arranged opposite to the molding surface of such mold part;
wherein the sensor means of the plurality of sensor means are adapted to generate a plurality of signals representative of respective strains of the detection surface in directions substantially perpendicular to the detection surface in the respective detection positions; and
(b) producing, in a plurality of detection positions, by said sensor means, a plurality of signals representative of respective strains of the detection surface of the first mold part and/or of the second mold part, in directions substantially perpendicular to the detection surface.

10. The method of claim 9, further comprising:
(c) transmitting said plurality of signals to an electronic control unit; and
(d) processing said plurality of signals by said electronic control unit.

11. The method of claim 10, further comprising:
(e) based on an outcome of the processing in step (d), carrying out an action of repairing the first mold part and/or the second mold part, the action of repairing comprising adding or removing material on one or more portions of the molding surface of the first mold part and/or of the second mold part.

12. A method for manufacturing a shell hull, in composite material, of a boat, the method comprising:
(x1) carrying out monitoring by a method for monitoring a mold for molding the shell hull, comprising:
(a) providing an apparatus for molding the shell hull, the apparatus comprising:
a first mold part and a second mold part, wherein the first mold part and the second mold part each have a respective molding surface,
the first mold part and the second mold part being adapted to be coupled to define jointly a concave molding cavity for molding the shell hull of the boat,
the molding cavity being delimited on two opposed sides by the respective molding surfaces of said first mold part and of said second mold part, and extending longitudinally between a stern end and a bow end;
a humidity sensor adapted to detect humidity at the first mold part and/or at the second mold part; and
a plurality of sensor means, arranged in a respective plurality of detection positions on a detection surface that extends on at least one of said first mold part and said second mold part, and arranged directly in contact with at least one of said first mold part and said second mold part, the detection surface being arranged opposite to the molding surface of such mold part;
wherein the sensor means of the plurality of sensor means are adapted to generate a plurality of signals representative of respective strains of the detection surface in directions substantially perpendicular to the detection surface in the respective detection positions; and
(b) producing, in a plurality of detection positions, by said sensor means, a plurality of signals representative of respective strains of the detection surface of the first mold part and/or of the second mold part, in directions substantially perpendicular to the detection surface;
(x2) arranging at least one layer of reinforcement material, or of fibrous material, inside said molding cavity; and
(x3) following step (x2), injecting a thermosetting resin inside said molding cavity so as to fill said molding cavity and/or to cover the molding surface.

13. The method of claim 12, further comprising:
(x4) following step (x3), having the at least one layer of reinforcement material, or of fibrous material, and the thermosetting resin inside of the molding cavity undergo a vacuum-bagged autoclave polymerization process, according to a specific pressure and temperature cycle.

14. The method of claim 12, further comprising:
(x5) prior to step (x2), arranging a layer of waxy material on the molding surface of the first mold part and/or of the second mold part.

15. The method of claim 12, wherein step (b) is carried out at least in part during at least one of step (x2) and step (x3).
